(19) United States
(12) Patent Application Publication
(10) Pub. No.: US 2010/0214464 A1
(43) Pub. Date: Aug. 26, 2010

(54) SOLID-STATE IMAGING APPARATUS

(75) Inventor: Takanori Watanabe, Yamato-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/697,408

(22) Filed: Feb. 1, 2010

(30) Foreign Application Priority Data
Feb. 23, 2009 (JP) 2009-039755

(51) Int. Cl. H04N 5/335

(52) U.S. Cl. 348/311; 348/E05.091

(57) ABSTRACT

A solid-state imaging apparatus includes: an electric charge collecting region (104) of a first conductivity type arranged on a semiconductor substrate to collect an electric charge; a first surface region (105) of a second conductivity type formed on a surface of the semiconductor substrate to cover at least a part of the electric charge collecting region; a floating diffusion region (103) of the first conductivity type; and an electrode (102) covering a whole surface of the electric charge collecting region, for biasing through a gate insulating film to transfer the electric charge in the electric charge collecting region to the floating diffusion region, wherein the electrode has a film thickness effective to transmit light, and, under the electrode, arranged are a portion spaced from the floating diffusion region and including the first surface region, and a portion closer to the floating diffusion region and not including the first surface region.

### BACKGROUND OF THE INVENTION

1. Field of the Invention

The present invention relates to a solid-state imaging apparatus to be used in a digital camera, a camcorder and the like.

2. Description of the Related Art

In recent years, a digital camera with a higher image quality and of a lower price is widely used according to the progress of the solid-state imaging apparatus. The performance of a CMOS sensor which has an active element in the pixel and can form a peripheral circuit on a chip, in particular, has been remarkably enhanced and accordingly has been replacing a CCD sensor.

A technology which has contributed to the enhancement of the image quality of the CMOS sensor includes a pinned photodiode structure, a complete transferring type photodiode and a CDS (Correlated Double Sampling) technology.

The complete transferring type photodiode has a function of giving a high electric potential to a transfer gate electrode to switch the transfer gate to an ON-state, and transferring all carriers in the photodiode to a floating diffusion region (hereinafter referred to as FD region), in a period of resetting the photodiode and reading out an electric potential Vout. Thereby, the photodiode is reset to an empty state of containing no electric charge therein.

The CDS technology is a technology of sampling and holding electric potentials before and after read-out in the FD region, calculating the difference to remove a reset noise in the FD region, and taking out a signal component corresponding to the normal optical signal. On the other hand, the CDS technology cannot remove the reset noise in the photodiode, but can inhibit the reset noise from being generated in the photodiode, by using the complete transferring type photodiode.

In the complete transferring type photodiode, an electric charge does not remain in the photodiode which has been reset, so the randomicity for every reset does not occur. One example of a pixel layout of the CMOS sensor which completely transfers all carriers is illustrated in FIG. 2 of Japanese Patent Application Laid-Open No. 2004-241498 (hereinafter referred to as Patent Document 1).

In FIG. 2 of Patent Document 1, a transfer transistor (transfer gate) for transferring the electric charge of the photoelectric conversion device (photodiode) is formed from a polygate (polysilicon), and is arranged so as to come in contact with one side of the periphery of the photoelectric conversion element.

In recent years, the pixel size is being reduced so as to impart a high definition to and miniaturize the product. As the pixel size is reduced, a problem of securing the area of the photodiode becomes larger.

The reduction of the area of the photodiode causes a problem that a dynamic range of the sensor is decreased because the photodiode cannot obtain a sufficient saturation electric charge. The reduced area of the photodiode further causes a problem of lowering the sensitivity.

In order to solve this problem, Japanese Patent Application Laid-Open No. 2005-142470 (hereinafter referred to as Patent Document 2) proposes one technology. This Patent Documents 2 proposes a technology of arranging a gate electrode all over the photodiode, and collecting a photo carrier generated by a light transmitted through the gate electrode, while controlling the gate electrode.

However, a structure described in Patent Document 2 imparts a high electric potential to the gate electrode and makes the photo carriers accumulated under the gate electrode, in the operation of accumulating photo carriers. Specifically, the photodiode in Patent Documents 1 makes the photo carriers accumulated on the surface part of the semiconductor which contacts a gate oxide film. In such an accumulation structure, the photodiode cannot be formed so as to be a buried type, and accordingly cannot inhibit a dark current from generating on the oxidation film interface.

### SUMMARY OF THE INVENTION

An object of the present invention is to provide a solid-state imaging apparatus which reduces a dark current and can remove a reset noise with the use of a CDS operation, and through which a photograph with a high S/N ratio can be taken even in a photographing environment of low luminance.

According to an aspect of the present invention, a solid-state imaging apparatus comprises: an electric charge collecting region of a first conductivity type arranged on a semiconductor substrate to accumulate an electric charge; a surface region of a second conductivity type formed on a surface of the semiconductor substrate to cover at least a part of the electric charge collecting region; a floating diffusion region of the first conductivity type; and an electrode covering a whole surface of the electric charge collecting region, for biasing through a gate insulating film to transfer the electric charge in the electric charge collecting region to the floating diffusion region, wherein the electrode has a film thickness effective to transmit light, and, under the electrode, arranged are a portion spaced from the floating diffusion region and including the surface region, and a portion closer to the floating diffusion region and not including the surface region.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a top view of a solid-state imaging apparatus according to a first embodiment of the present invention.

FIG. 2 is a sectional view of the solid-state imaging apparatus according to the first embodiment of the present invention, which is taken along the line 2-2 in FIG. 1.

FIG. 3 is a top view of a solid-state imaging apparatus according to a second embodiment of the present invention.

FIG. 4 is a sectional view of the solid-state imaging apparatus according to the second embodiment of the present invention, which is taken along the line 4-4 in FIG. 3.

FIG. 5 is an equivalent circuit diagram of a pixel according to the first embodiment of the present invention.

FIG. 6 is a driving timing diagram of the pixel according to the first embodiment of the present invention.

FIG. 7 is a sectional view of a solid-state imaging apparatus according to a third embodiment of the present invention.

The accompanying drawings, which are incorporated in and constitute a part of the specification, illustrate embodiments of the invention and, together with the description, serve to explain the principles of the invention.

### DESCRIPTION OF THE EMBODIMENTS

Preferred embodiments of the present invention will now be described in detail in accordance with the accompanying drawings.

### First Embodiment

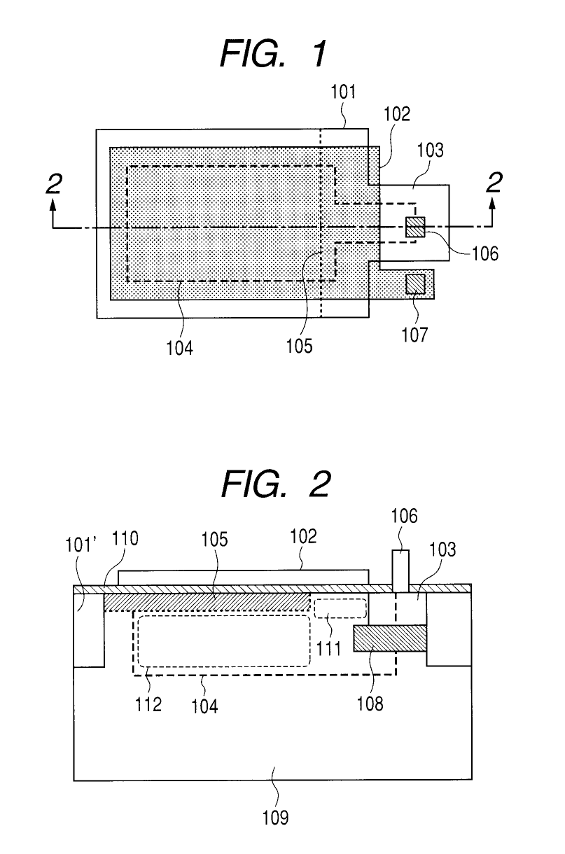

FIG. 1 is a top view of a solid-state imaging apparatus according to a first embodiment of the present invention, and FIG. 2 is a sectional view of the solid-state imaging apparatus, which is taken along the line 2-2 in FIG. 1. In FIG. 1, an active region 101 is shown. A region which has the common boundary with the active region 101 and surrounds the active region 101 forms a device-isolating region which is formed from a silicon oxide film buried in a silicon substrate. In FIG. 2, the region 101′ corresponds to the device-isolating region. An electrode 102 and an FD region 103 are shown. A collecting region 104 is a region which can accumulate electric charges generated by photoelectric conversion therein. A semiconductor substrate 109 is shown. The semiconductor substrate 109 employs, for instance, a substrate which is the same conductivity type as the type of the collecting region 104 and contains a lower concentration of impurities therein than those in the collecting region 104, but may employ a substrate which is a conductivity type opposite to the type of the collecting region 104 and contains a lower concentration of impurities therein than those in the collecting region 104. Furthermore, the semiconductor substrate 109 may be a substrate which has the same low concentration as in the collecting region 104 but is an opposite conductivity type of wells formed therein. The collecting region 104 has also a function of a photoelectric conversion section (photodiode). A surface region 105 is a region formed by a semiconductor having a conductivity type different from that of the collecting region 104. As the surface region 105 exists there, the collecting region 104 can be prevented from coming in contact with the interface to be formed by a gate insulating film 110, and can realize a pinned photodiode structure. Contact holes 106 and 107 are shown. The contact hole 106 electrically connects the FD region 103 to and the contact hole 107 electrically connects the electrode 102 to a wiring layer (not shown). A field stop region 108 plays a role of potential isolation between electric charges in the collecting region 104 and the FD region 103.

The device-isolating region 101′ can be formed, for instance, by STI (shallow trench isolation). The electrode 102 can employ, for instance, a thin film of polysilicon. The thickness of the polysilicon film may be as thin as to be capable of securing sufficient transmissivity with respect to light having wavelengths to be received by the sensor. The FD region 103 can be formed, for instance, with a self alignment type of an ion implantation technique, after the electrode 102 has been formed. An n-type impurity diffusion layer can be formed by using P or As as the ion. The collecting region 104 and the surface region 105 can be formed, for instance, with an ion implantation technique while using a resist pattern, before forming the electrode 102. The collecting region 104 can be formed of the n-type impurity diffusion layer with the use of P or As, and the surface region 105 can be formed of a P-type impurity diffusion layer by the implantation of B or BF₂. The field stop region 108 can be formed by a self alignment type of an ion implantation technique after the electrode 102 has been formed or also in a state of leaving a resist used when the electrode 102 has been patterned. The field stop region 108 can be formed with an ion implantation technique with the use of B or BF2, and can be formed of a P-type impurity diffusion layer. A gate insulating film 110 can employ, for instance, a silicon oxide film as well.

In the present embodiment, the collecting region 104 has an offset with respect to a device-isolating region 101′. Thereby, a dark current can be inhibited from being generated because of the interface between the collecting region 104 and the device-isolating region 101′. In the present embodiment, in FIG. 1, the electrode 102 is formed so as to cover the collecting region 104.

In the present embodiment, a transfer gate having a function of transferring an electric charge in the collecting region 104 to the FD region 103 and the electrode 102 which covers the collecting region 104 itself are integrated.

Patent Document 1 and Patent Document 2 which have been described in BACKGROUND OF THE INVENTION do not refer, but according to an investigation made by the present inventors, there is the following problem in a case in which a light is condensed in a small photodiode through a microlens or the like.

The light which has been vertically incident on a pixel is condensed in the vicinity of the center of the photodiode by an effect of the microlens and the like. However, on the end part of the imaging region, the light to be incident on the pixel is incident while forming some inclination with respect to a vertical direction. In the case, an incident position of the light condensed by the microlens deviates from the center of the photodiode. In Patent Document 1, when the light is obliquely incident from the left direction with an angle, the condensed region overlaps with the polysilicon gate of a transfer transistor. On the contrary, when the light is obliquely incident from the right direction with an angle, the condensed region overlaps with a device-isolating region. The polysilicon gate has high absorptivity for a light of a short wavelength and has low absorptivity for a light of a long wavelength, so the quantity of the light reaching the semiconductor region varies depending on the incident angle because of the wavelength dependency. In addition, according to an experiment by the present inventors, even when the light incident on the semiconductor region is not incident on a photoelectric conversion region, photo carriers flow into the photoelectric conversion region stochastically.

As a result, the wavelength dependency of a rate of generating the photo carriers in the photodiode, in other words, the spectral responsivity characteristics varies depending on the incident angle. This is a factor of aggravating color uniformity in the screen.

On the other hand, in the present embodiment, the transfer gate and the electrode 102 which covers the collecting region are integrated to include the whole surface of the collecting region, and thereby can inhibit the spectral responsivity from varying depending on an incident angle of light. Therefore, in the solid-state imaging apparatus according to the present embodiment, the color uniformity in the imaging region is improved.

Furthermore, the present embodiment shows the following effect. There is an F value of an object lens as one of an optical factor of a phenomenon that the light is obliquely incident. In order to take in a larger quantity of light when taking a picture, a diaphragm is approached to an opened state, the F value is decreased, and the picture is taken. When the F value is decreased, the light to be incident on one microlens results in being not only a vertically incident light but also the total quantity of the lights incident from various angles. In other words, when the F value is varied, the angles of the incident light also vary. The above fact causes a problem that the color of the image varies depending on the F value due to a similar principle to the above described problem. The solid-state imaging apparatus according to the present embodiment can show an effect of reducing this problem.

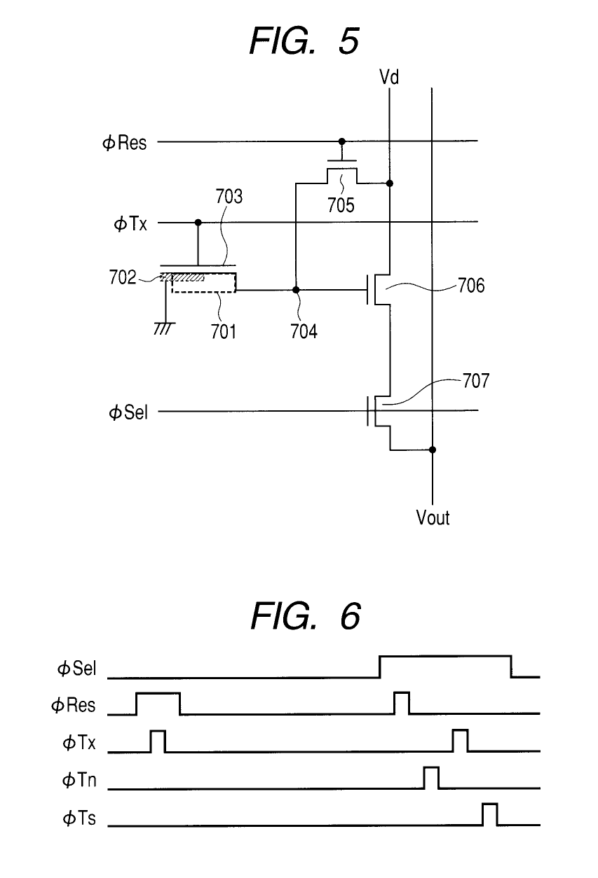

FIG. 5 is an equivalent circuit diagram of a pixel according to the present embodiment, and FIG. 6 is a timing diagram appearing when the pixel according to the present embodiment is driven. The semiconductor substrate has a plurality of pixels provided thereon. The method of driving the solid-state imaging apparatus according to the present embodiment will now be described below with reference to FIG. 5 and FIG. 6. A collecting region 701, a surface region 702, an electrode 703, an FD region 704, a reset transistor 705, a source follower transistor 706 and a selection transistor 707 are shown. Before an exposure period starts, the photodiode (collecting region) 701 is reset to be an empty state by turning the reset transistor 705 and the transfer gate 703 on with signals φRes and φTx. The exposure period is finished and CDS is operated according to the following driving procedure. The selection transistor 707 is turned on by a signal φSel, and the line to be read out is selected. Then, the reset transistor 705 is turned on by the signal φRes, and the FD region 704 is reset. The electric potential Vout appearing at the time is read out by the signal φTn, and is sampled and held in a memory (not shown) of the circuit section. The signal shown at the time becomes a noise signal. Subsequently, the transfer gate 703 is turned on by a signal φTx, and the photo carrier in the collecting region 701 is transferred to the FD section 704. Then, the electric potential Vout is sampled and held in the memory (not shown) of a read-out circuit section by the signal φTs. The signal generated at the time becomes a pixel signal. The pixel signal corresponding to the photo carriers can be read out by calculating the difference between the pixel signal and the noise signal which have been accumulated in the memory.

The method for transferring electric charges in the solid-state imaging apparatus according to the present embodiment will now be described. Incidentally, the photo carrier described here is an electron. A large difference between driving procedures according to the present embodiment and Patent Document 2 described in BACKGROUND OF THE INVENTION is in a way of imparting an electric potential to be applied to a gate electrode (electrode 703 in the present embodiment). A solid-state imaging apparatus according to Patent Document 2 gives a high electric potential to the gate electrode in order to collect the photo carriers on the interface of the gate insulating film in an accumulation period and gives a low electric potential to the gate electrode in a transfer period. On the contrary, the solid-state imaging apparatus according to the present embodiment gives a low electric potential to the gate electrode in the accumulation period not to accumulate the photo carriers in the vicinity of the interface of the gate insulating film. Thereby, the apparatus shows an effect of remarkably reducing the dark current value. The apparatus according to the present embodiment transfers the photo carriers by giving a high electric potential to the electrode 703.

A mechanism through which the photo carriers can be completely transferred in the present embodiment will now be described below with reference to FIG. 1 and FIG. 2. The surface region 105 is not formed in the side of contacting the FD region 103, but is formed in a side distant from the FD region 103. An active region 111 under the electrode is an active region 111 which is formed under the electrode 102. The active region 111 under the electrode existing in a side close to the FD region 103 is sensitively influenced by the modulation of the potential due to the change of an electric potential of the electrode 102. On the other hand, the surface region 105 is the same conductivity type as that of the semiconductor substrate 109, and is fixed at the same electric potential as that of the semiconductor substrate 109. Accordingly, the active region 112 under the electrode existing in a side far from the FD region 103 is hardly influenced by the modulation of the potential due to the change of an electric potential of the electrode 102. Therefore, when a high electric potential is given to the electrode 102, the photo carriers move to the active region 111 under the electrode existing in a side close to the FD region 103 from the active region 112 under the electrode existing in a side far from the FD region 103. Furthermore, a high reset potential is given to the FD region 103, so the photo carriers are transferred to the FD region 103.

As was described above, the solid-state imaging apparatus according to the present embodiment can secure the area of the photodiode even when a small pixel is formed, and improve the sensitivity and the saturation. The provided solid-state imaging apparatus can also realize a pinned photodiode structure and can decrease the dark current and the noise. Furthermore, the apparatus inhibits the color ununiformity from occurring in the screen also when images have been formed in the imaging region by using the object lens.

### Second Embodiment

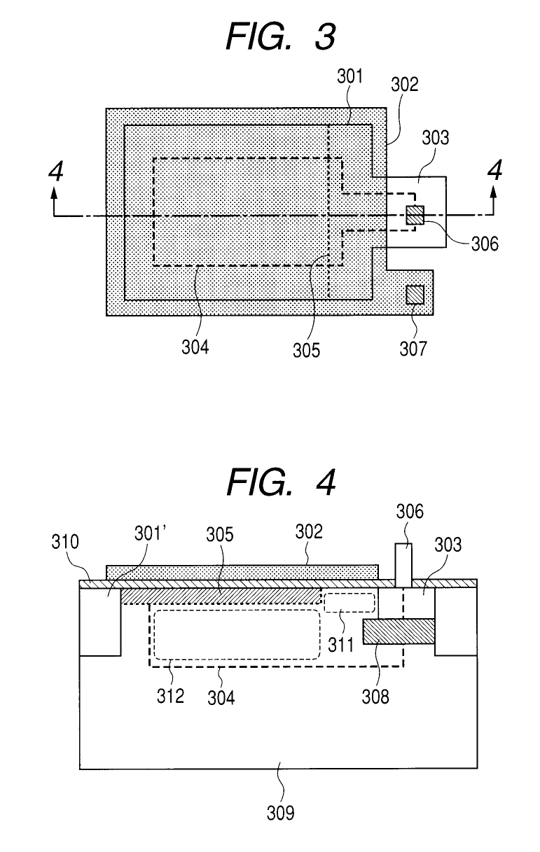

FIG. 3 is a top view of a solid-state imaging apparatus according to a second embodiment of the present invention, and FIG. 4 is a sectional view of the solid-state imaging apparatus, which is taken along the line 4-4 in FIG. 3. Respective parts numbers 301 to 312 denote the same portions as 101 to 112 in the first embodiment. The same equivalent circuit of the pixel and the driving timing as those in the first embodiment can be selected in the present embodiment as well. The feature of the present embodiment exists in a point of arranging the electrode 302 so as to overlap the whole active region 301. The structure according to the present embodiment can realize the same pinned photodiode structure as in the first embodiment, and can inhibit the dark current. Furthermore, in the present embodiment, the electrode 302 is formed even above an edge part of an STI region, and accordingly can control the potential of the edge part of the STI region. Thereby, the structure can control the concentration of minority carriers in the vicinity of the edge part of the STI region to which a large stress is applied, and can reduce a value of the dark current.

In addition, the structure according to the present embodiment can show the following effect. The structure according to the present embodiment can lay out the electrode 302 so as to have a larger area, and can improve the sensitivity and the cross talk with adjacent pixels. A phenomenon that an incident light reflects or diffracts on its side face is confirmed to occur on the end part of electrode 302. The structure according to the present embodiment can arrange the end part of the electrode 302 farther from the center of the collecting region 304 than that in the first embodiment. Therefore, the structure according to the present embodiment can inhibit an optical influence on the end part of the electrode 302, and can reduce the cross talk with the adjacent pixels. The effect results in not only enhancing the resolution, but also improving the color reproducibility in a single-plate type color imaging device which mounts a color filter thereon.

### Third Embodiment

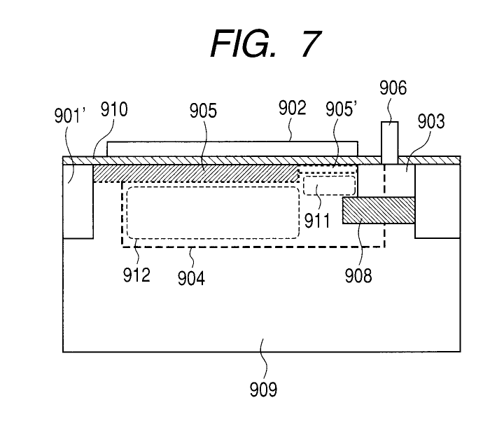

FIG. 7 is a sectional view of a solid-state imaging apparatus according to a third embodiment of the present invention, which is taken along the line 2-2. Respective parts numbers 901 to 912 denote the same portions as 101 to 112 in the first embodiment. The same equivalent circuit of the pixel and the driving timing as those in the first embodiment can be selected in the present embodiment as well. The feature of the present embodiment exists in a point of forming a second surface region 905′ in addition to the first surface region 905.

The second surface region 905′ has a lower concentration of impurities or a shallower depth than that of the first surface region 905. When a high electric potential is applied to an electrode 902, the photo carriers can be transferred to an FD region 903 in a similar way to the first embodiment, by depleting the second surface region 905′ or enabling an inversion layer to be formed.

The structure according to the present embodiment can show the effect obtained in the first embodiment, more easily realize a buried structure of the photodiode and reduce the dark current in an accumulation period. In other words, the structure can easily bury the second surface region 905′ in the substrate, and accordingly can more effectively inhibit the dark current from generating in the vicinity of the second surface region 905′.

In the above described first to third embodiments, the photo carrier to be collected is an electron, but a positive hole which is a photo carrier can be also collected. In this case, the apparatus can be formed by reversing the polarity of each impurity diffusion region. In addition, as for a driving pulse, the positive hole can be completely transferred by reversing the level of the electric potential. In this case as well, the effect obtained in the first to third embodiments in the present invention can be shown.

The solid-state imaging apparatus according to the first to third embodiments can secure sufficient sensitivity and saturation even when having its pixel size refined, and can realize a complete transmission type and buried type of photodiode. Specifically, the solid-state imaging apparatus can realize such a pixel structure as to satisfy all requirements of having a photodiode with a gate electrode arranged on its surface, a pinned photodiode structure and a complete transferring type photodiode. Thereby, the solid-state imaging apparatus with a small size and high definition can take an image in a wide dynamic range with a low noise and high sensitivity.

The solid-state imaging apparatus according to the first to third embodiments has an electric charge collecting region 104 of a first conductivity type, which is formed on a semiconductor substrate 109 and the like, and collects electric charges, and the like. A first surface region 105 of a second conductivity type and the like are formed on a surface of the semiconductor substrate 109 and the like while covering at least one part of the electric charge collecting region 104 and the like. A floating diffusion region 103 of the first conductivity type and the like are regions which can collect the electric charge. An electrode 102 and the like cover the whole surface of the electric charge collecting region 104 and the like, and transfer the electric charges in the electric charge collecting region 104 and the like to the floating diffusion region 103 and the like through a gate insulating film 110 and the like formed on the semiconductor substrate 109 and the like.

The electrode 102 and the like have a film thickness effective to transmit light. Under the electrode 102 and the like, there are a portion which is spaced from the floating diffusion region 103 and the like and includes the first surface region 105 and the like, and a portion which is close to the floating diffusion region 103 and the like and does not include the first surface region 105 and the like.

The solid-state imaging apparatus imparts such an electric potential as to attract the above described electric charge toward a surface side of the semiconductor substrate 109 and the like, to the electrode 102 and the like, in a period of transferring the electric charges in the electric charge collecting region 104 and the like to the floating diffusion region 103 and the like. The electric charge collecting region 104 and the like can accumulate the electric charges therein which have been generated through photoelectric conversion.

In the first and second embodiments, a portion which exists under the electrode 102, is close to the floating diffusion region 103 and the like and does not include the first surface region 105 and the like (active region 111 under electrode and the like) has the same conductivity type as that of the electric charge collecting region 104 and the like.

In the third embodiment, a portion which is close to the floating diffusion region 903 and does not include the first surface region 905 is a second surface region 905′. The portion (second surface region 905′) under the electrode 902, which is close to the floating diffusion region 903 and does not include the first surface region 905, has less impurity concentration than another portion under the electrode 902, which is spaced from the floating diffusion region 903 and includes the first surface region 905.

The solid-state imaging apparatus according to the first to third embodiments generates a dark current little, can remove the reset noise with a CDS operation, and can take an image with a high S/N ratio even in an imaging environment of low illuminance. In addition, the solid-state imaging apparatus according to the first to third embodiments can secure sufficient sensitivity and saturation even when having its pixel size refined, and can realize a complete transmission type and buried type of photodiode. As a result, the solid-state imaging apparatus with a small size and high definition can take an image in a wide dynamic range with a low noise and high sensitivity.

All of the above described embodiments merely show examples for embodiment necessary when carrying out the present invention, and the scope of the present invention should not be definitely interpreted by the embodiments. In other words, the present invention can be conducted in various forms as long as the form does not depart from the technological thought or the principal feature of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-039755, filed Feb. 23, 2009, which is hereby incorporated by reference herein in its entirety.

What is claimed is:

1. A solid-state imaging apparatus comprising:
an electric charge collecting region of a first conductivity type arranged on a semiconductor substrate to accumulate an electric charge;
a surface region of a second conductivity type formed on a surface of the semiconductor substrate to cover at least a part of the electric charge collecting region;
a floating diffusion region of the first conductivity type; and
an electrode covering a whole surface of the electric charge collecting region, for biasing through a gate insulating film to transfer the electric charge in the electric charge collecting region to the floating diffusion region, wherein
the electrode has a film thickness effective to transmit light, and,
under the electrode, arranged are a portion spaced from the floating diffusion region and including the surface region, and a portion closer to the floating diffusion region and not including the surface region.

2. The solid-state imaging apparatus according to claim 1, wherein,
under the electrode, the portion spaced from the floating diffusion region and including the surface region has a higher impurity concentration rather than the portion closer to the floating diffusion region and not including the surface region.

3. The solid-state imaging apparatus according to claim 1, wherein,
under the electrode, the portion spaced from the floating diffusion region and including the surface region has the same conductivity type as that of the electric charge collecting region.

4. The solid-state imaging apparatus according to claim 1, wherein,
during a period in which the electric charge accumulated in the electric charge collecting region is transferred to the floating diffusion region, a potential for biasing the electric charge toward the surface of the semiconductor substrate is applied to the electrode.

5. The solid-state imaging apparatus according to claim 1, wherein
the electric charge collected by the electric charge collecting region is one generated by a photoelectric conversion.
